(19) United States
(12) Patent Application Publication
(10) Pub. No.: US 2024/0077419 A1
(43) Pub. Date: Mar. 7, 2024

(54) DIFFUSE MULTI-REFLECTION OPTICAL DEVICE WITH LIGHT RE-DIRECTION FOR SPECTROMETER COLLECTION

(71) Applicant: Si-Ware Systems, Cairo (EG)

(72) Inventors: Mohamed Sadek Radwan, Cairo (EG); Bassem Mortada, Cairo (EG); Shady Labib, Cairo (EG); Mostafa Medhat, Cairo (EG); Yasser M. Sabry, Cairo (EG); Mazen Erfan, Cairo (EG)

(21) Appl. No.: 18/240,595

(22) Filed: Aug. 31, 2023

Related U.S. Application Data
(60) Provisional application No. 63/403,160, filed on Sep. 1, 2022.

(51) Int. Cl. G01N 21/47; G01N 21/25; G02B 5/122

(52) U.S. Cl. CPC G01N 21/474; G01N 21/255; G02B 5/122; G01N 2021/4754; G01N 2021/4761; G01N 2201/06146

(57) ABSTRACT

Aspects relate to mechanisms for enhancing the coupling of scattered light from a sample under test into a spectrometer. An optical device can include a reflective surface positioned apart from the sample and configured to receive a first portion of scattered light from the sample and to redirect the first portion of the scattered light back to one or more discrete spots on the sample in a non-random manner to produce redirected scattered light from the sample. The spectrometer may then be configured to receive coupled light from the sample including at least a portion of the redirected scattered light.

### PRIORITY CLAIM

This application claims priority to and the benefit of Provisional Application No. 63/403,160, filed in the U.S. Patent and Trademark Office on Sep. 1, 2022, the entire content of which is incorporated herein by reference as if fully set forth below in its entirety and for all applicable purposes.

### TECHNICAL FIELD

The technology discussed below relates generally to optical spectroscopy including diffuse reflectance and transmission spectroscopy, and in particular, to mechanisms to effectively increase the spectrometer collection for better performance with inhomogeneous samples and increased sensitivity.

### BACKGROUND

Diffuse reflectance spectroscopy may be utilized to study the molecular structure of a given material based on its spectral response. In diffuse reflectance spectroscopy, a light source (e.g., a wide band light source) shines light onto the material under test. The incident light interacts with the material such that part of the light is transmitted, another part of the light is reflected, and another part of the light is scattered. The scattered portion is affected by the sample absorption spectrum and can be used to identify the material based on its spectral print. Diffuse reflectance spectroscopy can be used with different forms of the material, such as solids, powders, and liquids.

Although the absorption spectrum is mainly determined by the material itself, measurement errors can start to appear if the scattered light does not fully represent the measured sample. This can be attributed to many reasons. For example, one reason is related to using an inhomogeneous sample. This means that the material has different regions where the absorbance spectrum varies depending on the measurement position. Another reason is related to the size and the shape of the material macroscopic particle size. Various materials can exhibit a wide range of macroscopic particle forms, spanning from fine particles found in powders to large spherical grains with diameters measuring a few millimeters. Materials like grains, e.g., corn kernels, demonstrate both inhomogeneity and particle size variations. For example, corn can have kernels with irregular shapes with lengths that vary from 5 mm to 20 mm. In this example, the scattered light is dominated by the part of the kernel that is aligned with the spectrometer's field of view. This makes a single measurement representative for only a small part of the corn kernel. Typically, corn kernels may have different absorption spectrums depending on the measurement position. In addition, it is difficult to measure multiple kernels in the same measurement due to the limited spectrometer field of view. Furthermore, this shape irregularity can affect the scattered light that can be collected into the spectrometer, which affects the signal-to-noise ratio (SNR) of the spectrometer measurement.

Conventional spectrometers may overcome these issues through an initial step of sample preparation. Such a sample preparation step usually involves grinding the material to form a homogenous powder. Such a sample preparation process, while feasible in the laboratory, may not be an easy task in the field for a portable spectrometer or in a production line for quality control. The evolution of portable and handheld spectrometers in the last decade has resulted in improvements in the sample interface to overcome the above-mentioned issues. For example, one way to overcome the sample inhomogeneity issue is to increase the spectrometer field of view. This helps average the sample response across the different inhomogeneous regions and ensures that the different regions are well represented in the scattered light and collected light inside the spectrometer.

However, increasing the spectrometer field of view may not be practical in some cases, especially when there are limitations in the acceptance angle and the aperture size of the spectrometer. This can be the case of handheld and portable spectrometers. Many of these spectrometers are based on MEMS (Micro-Electro-Mechanical Systems) components that typically have smaller optical surfaces which accordingly limit the optical throughput of the whole spectrometer. Such limitations impose constraints on the achieved field of view with enough optical coupled power. For example, increasing the area viewed by the spectrometer with limited optical throughput may decrease the coupled optical power coupled, which may result in a reduction in the SNR. A degraded SNR can greatly affect the material analysis and introduce errors in the chemo-metrics models.

### SUMMARY

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In an example, an optical device is disclosed including a reflective surface positioned apart from a sample and configured to receive a first portion of scattered light from the sample and to redirect the first portion of the scattered light back to one or more discrete spots on the sample in a non-random manner to produce redirected scattered light from the sample. The optical device further includes a spectrometer configured to receive coupled light from the sample at an input thereof and to obtain a spectrum of the sample based on the coupled light. The coupled light includes at least a portion of the redirected scattered light.

Another example provides a method for increasing collection of a spectrometer. The method includes receiving a first portion of scattered light from a sample at a reflective surface positioned apart from the sample, redirecting the first portion of the scattered light back to one or more discrete spots on the sample in a non-random manner to produce redirected scattered light from the sample, and receiving coupled light from the sample at an input of the spectrometer to obtain a spectrum of the sample based on the coupled light. The coupled light includes at least a portion of the redirected scattered light.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating a spectrometer as an optical system according to some aspects.

FIG. 2 is a diagram illustrating an example of scattered light coupled into a spectrometer according to some aspects.

FIG. 3 is a diagram illustrating an example of an optical device with light redirection for spectrometer collection according to some aspects.

FIG. 4 is a diagram illustrating another example of an optical device with light redirection for spectrometer collection according to some aspects.

FIG. 5 is a diagram illustrating another example of an optical device with light redirection for spectrometer collection according to some aspects.

FIG. 6 is a diagram illustrating another example of an optical device with light redirection for spectrometer collection according to some aspects.

FIG. 7 is a diagram illustrating another example of an optical device with light redirection for spectrometer collection according to some aspects.

FIG. 8 is a diagram illustrating another example of an optical device with light redirection for spectrometer collection according to some aspects.

FIG. 9 is a diagram illustrating another example of an optical device with light redirection for spectrometer collection according to some aspects.

FIGS. 10A and 10B are diagrams illustrating another example of an optical device with light redirection for spectrometer collection according to some aspects.

FIG. 11 is a diagram illustrating another example of an optical device with light redirection for spectrometer collection according to some aspects.

FIG. 12 is a diagram illustrating another example of an optical device with light redirection for spectrometer collection according to some aspects.

FIG. 13 is a diagram illustrating another example of an optical device with light redirection for spectrometer collection according to some aspects.

FIG. 14 is a diagram illustrating another example of an optical device with light redirection for spectrometer collection according to some aspects.

FIG. 15 is a diagram illustrating another example of an optical device with light redirection for spectrometer collection according to some aspects.

FIG. 16 is flow chart illustrating an exemplary method for light redirection for spectrometer collection from a sample according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Spectroscopy may be utilized, for example, to characterize the chemical content of solids, liquids and gases. Spectrometers analyze and interact with the sample under test using various mechanisms, such as transmission or diffuse reflectance sampling. Transmission is commonly used with liquid samples or gases. In this configuration, the light passes through the sample under test and then is coupled into the spectrometer after interacting with the molecules of the sample. In diffuse reflectance sampling, the light is incident on the sample under test and the scattered light from the sample is collected and coupled into the spectrometer. Diffuse reflectance is mostly used for solids.

In both cases, the light collected by the spectrometer only interacts with a limited portion of the sample. In some applications, the sample is not homogenous and can have a large particle size. Measuring a small spot size in this case may not be representative of the sample spectral properties. This can be observed in the measured spectrum as a large variation across the different locations on the sample. For example, in grain analysis, the particle size can vary from 5-20 mm, and accordingly, the optical system of the spectrometer should be able to accommodate this large spot size. In most of the current systems available in the market, the sample is measured several times at different positions and then the readings are averaged together. In this disclosure, a technique is provided to increase the spot size of the spectrometer and ultimately increase the accuracy of the chemo-metrics models to simultaneously couple the light from the different locations from the sample at the same time.

In particular, aspects are directed to techniques to redirect scattered light from a sample to one or more spots on the sample in a non-random manner to increase the effective spot size area. In some examples, a portion of the scattered light from a spot on the sample may be directly coupled into the spectrometer, while a remaining portion of the scattered light may be redirected back to the spot on the sample to increase the effective size of the spot and to further increase the optical power of the optical device. In other examples, the scattered light from a first spot on the sample that is out of the field-of-view of the spectrometer may be redirected to a second spot on the sample that is within the field-of-view of the spectrometer, where the first and second spots collectively form an extended spot area on the sample.

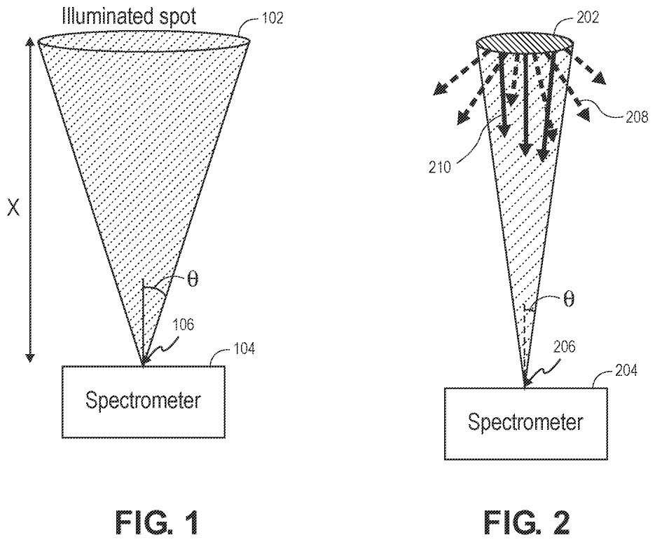

FIG. 1 is a diagram illustrating a spectrometer 104 as an optical system according to some aspects. The spectrometer 104 may be, for example, a Fourier Transform infrared (FTIR) spectrometer. In some examples, the spectrometer 104 may include a Michelson interferometer or a Fabry-Perot interferometer.

The spectrometer 104 as an optical system can be simplified as an aperture 106 with certain dimensions (e.g., diameter) and an acceptance angle θ. The acceptance angle θ represents an angle of a head of a cone of light optically coupled into the spectrometer 104 from an illuminated spot 102 on a sample. For example, light passing through the sample or reflected from (e.g., scattered from) the sample may be optically coupled from the illuminated spot 102 towards the spectrometer 104. The throughput of the spectrometer 104 shown in FIG. 1 may be written as:

Throughput∝aperture diameter²×sin²(θ). (Equation 1)

The distance between the sample interface and the spectrometer input surface may be represented as X, as shown in FIG. 1. If the distance X is large as compared to the diameter of the aperture 106, and the collected spot area of the illuminated spot 102 is much larger than the area of the aperture 106, the effective area (e.g., field of view) seen by the spectrometer may be approximated by the following relation:

Spot diameter≈2×tan(θ). (Equation 2)

Based on Equations 1 and 2 above, the key limitation in spectrometer optical systems in terms of the collection spot size may be considered the acceptance angle θ of the system. In miniaturized spectrometers where the input aperture 106 has a small area and acceptance angle, the performance of such spectrometers may be limited to homogeneous samples that have almost constant spectral response across different locations on the sample.

FIG. 2 is a diagram illustrating an example of scattered light coupled into a spectrometer 204 according to some aspects. The spectrometer 204 may be, for example, a Fourier Transform infrared (FTIR) spectrometer operating in a diffuse reflectance mode. In some examples, the spectrometer 204 may include a Michelson interferometer or a Fabry-Perot interferometer. As described in the example shown in FIG. 1, light may be optically coupled into the spectrometer 204 from an illuminated spot 202 on a sample towards the spectrometer 204 based on diffuse reflectance of light scattered from (e.g., reflected from) the sample. As can be seen in FIG. 2, the scattered light from the sample may include a first portion of scattered light 208 and a second portion of scattered light 210. The first portion of scattered light 208 is scattered outside of an aperture 206 and acceptance angle θ of the spectrometer 204, and as a result, does not reach the input to the spectrometer 204. The first portion of scattered light 208 thus represents useless scattered light from the sample. The second portion of scattered light 210 is coupled directly into the spectrometer 204 based on the aperture 206 and acceptance angle θ, and thus, represents useful scattered light from the sample.

In various aspects of the disclosure, techniques are provided to redirect the useless scattered light 208 from the sample back to the sample surface to increase the light interaction with the sample and collect more information from the sample, hence averaging the measured spectra, which results in an enhancement in coupling light to the spectrometer 204. Various aspects provide different mechanisms to extend the coupled spot size and effectively achieve a larger field of view. In some examples, the spot can be coupled from different locations on the sample at the same time, which may decrease the measurement time if the sample is inhomogeneous since less averaging is needed to cover the whole sample.

In some aspects, a reflective surface is used to redirect the scattered light 208 that is typically missed in the input aperture and acceptance angle of the spectrometer back to the sample. This redirected light interacts with the sample again and the scattered back part of this scattered light is coupled into the spectrometer. The coupled power into the spectrometer then includes the contribution from the first sample reflection and the second sample reflection. Depending on the reflective surface and material of the sample under test characteristics, light may be trapped between the reflective surface and the sample. In this example, light may be coupled after multiple reflections from the sample.

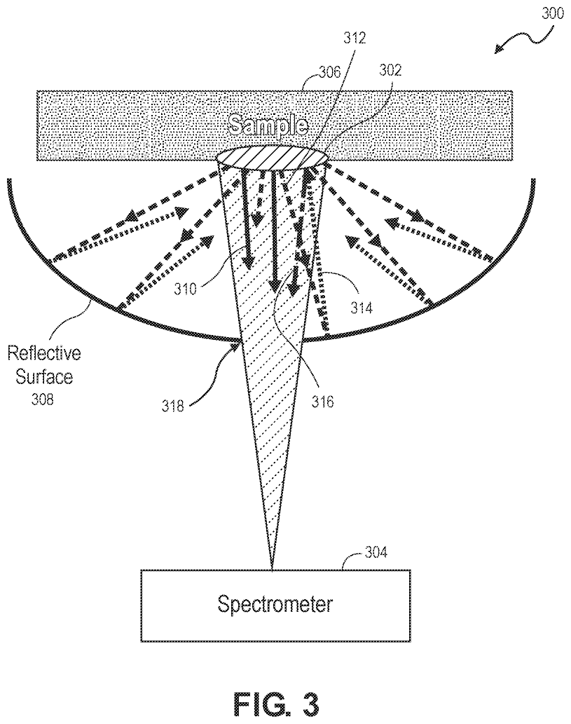

FIG. 3 is a diagram illustrating an example of an optical device with light redirection for spectrometer collection according to some aspects. The optical device 300 includes a spectrometer 304 configured to receive coupled light from a sample 306 at an input thereof and to obtain a spectrum of the sample 306 based on the coupled light. The spectrometer 304 may be, for example, a Fourier Transform infrared (FTIR) spectrometer operating in a diffuse reflectance mode. For example, the spectrometer 304 may include an FTIR interferometer configured to produce an interferogram that may be detected by a detector. The output of the detector may be processed to obtain the spectrum of the detected light, which may then be utilized to identify various parameters associated with the sample 306 under test. In some examples, the spectrometer 304 may include an interferometer (e.g., a Michelson and/or Fabry-Perot interferometer), which may be implemented, for example, as a micro-electro-mechanical-systems (MEMS) spectrometer. As used herein, the term MEMS refers to the integration of mechanical elements, sensors, actuators and electronics on a common substrate through microfabrication technology. For example, the microelectronics are typically fabricated using an integrated circuit (IC) process, while the micromechanical components are fabricated using compatible micromachining processes that selectively etch away parts of the silicon wafer or add new structural layers to form the mechanical and electromechanical components. One example of a MEMS element is a micro-optical component having a dielectric or metallized surface working in a reflection or refraction mode. Other examples of MEMS elements include actuators, detector grooves, and fiber grooves. In some examples, a MEMS spectrometer may include one or more micro-optical components (e.g., one or more reflectors or mirrors) that may be moveably controlled by a MEMS actuator. For example, the MEMS spectrometer may be fabricated using a deep reactive ion etching (DRIE) process on a silicon-on-insulator (SOI) substrate in order to produce the micro-optical components and other MEMS elements that are able to process free-space optical beams propagating parallel to the SOI substrate.

In the example shown in FIG. 3, light may be coupled into the spectrometer 304 from an illuminated spot 302 on the sample 306 based on the input aperture and acceptance angle of the spectrometer 304, as described above. For example, light incident on the illuminated spot 302 is scattered by the sample 306. The scattered light covers a half sphere solid angle. Scattered light within the acceptance numerical aperture of the spectrometer 304 is directly coupled into the spectrometer 304 as directly coupled scattered light 310. However, due to the limited spectrometer numerical aperture, the directly coupled scattered light 310 represents a small portion of total scattered light.

Therefore, in aspects of the disclosure, as shown in FIG. 3, a reflective surface 308 is positioned apart from (e.g., surrounding) the sample 306. The reflective surface 308 has a curvature configured to receive a first portion of the scattered light (e.g., missed scattered light) 312 scattered outside of the numerical aperture of the spectrometer 304 and to redirect the missed scattered light 312 back towards the sample 306 as reflected scattered light 314 to increase the effective spot size of the spot 302. In this example, the directly coupled scattered light 310 directly coupled from the sample 306 into the spectrometer 304 may correspond to a second portion of the scattered light. The reflected scattered light 314 can interact again with the sample 306 to produce redirected scattered light that may be coupled into the spectrometer 304 as indirectly coupled redirected scattered light 316. Thus, the spot 302 may have an extended spot size based on the redirected scattered light 314 (e.g., as a result of different angles of light being incident on the sample 306 that may then be coupled into the spectrometer 304). The reflective surface 308 may further have a hole 318 therein for coupling of scattered light including the directly coupled scattered light 310 and the indirectly coupled redirected scattered light 316 into the spectrometer 304. In the example shown in FIG. 3, the reflective surface 308 is a half-sphere.

In some examples, the redirected scattered light may produce a scattering pattern that covers the half sphere solid angle. Part of these scattered rays (e.g., indirectly coupled redirected scattered light 316) can be coupled into the spectrometer acceptance angle, while the remainder of the redirected scattered light (e.g., additional missed scattered light) can again be collected by the reflective surface 308 and redirected once more to the sample 306 to produce additional redirected scattered light that may be coupled into the spectrometer 304. The same process can occur multiple times with multiple redirections of the missed scattered light; however, less power may be coupled each time due to light leakage through the sample 306 and the coupling hole 318 to the spectrometer 304. Therefore, the coupled light (coupled power) to the spectrometer 304 may be represented as:

Coupled power=Directly coupled scattered light from first interaction+Indirectly coupled Redirected Scattered Light from second interaction (Equation 3)

More generally though, the spectrometer 304 is configured to receive coupled light including the second portion of the scattered light (e.g., directly coupled scattered light 310) and at least a portion of the redirected scattered light (e.g., indirectly coupled redirected scattered light 316), which can include redirected scattered light from multiple subsequent interactions with the sample.

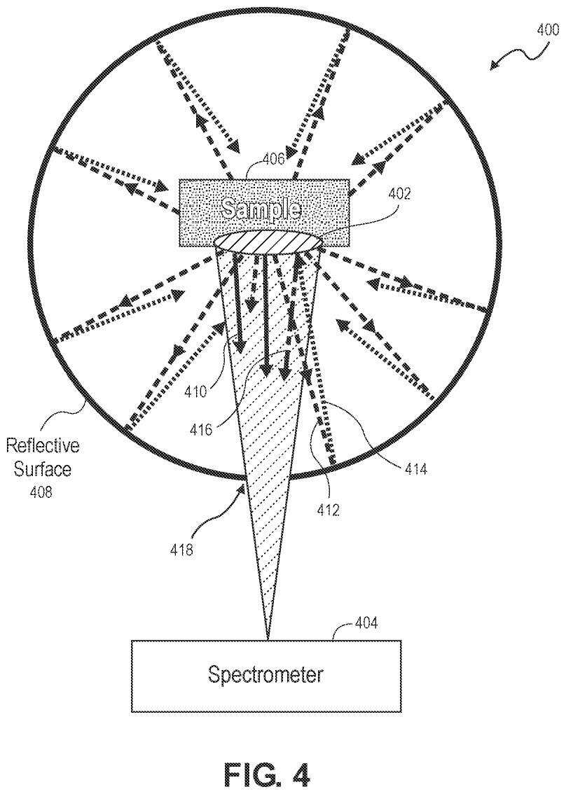

FIG. 4 is a diagram illustrating another example of an optical device with light redirection for spectrometer collection according to some aspects. The optical device 400 includes a spectrometer 404 configured to receive coupled light from a sample 406 at an input thereof and to obtain a spectrum of the sample 406 based on the coupled light. The spectrometer 404 may be, for example, a Fourier Transform infrared (FTIR) spectrometer operating in a diffuse reflectance mode. In the example shown in FIG. 4, light incident on an illuminated spot 402 on the sample 406 may be scattered by the sample 406. Scattered light within the acceptance numerical aperture of the spectrometer 404 is directly coupled into the spectrometer 404 as directly coupled scattered light 410.

In addition, in the example shown in FIG. 4, the scattered light covers a full sphere solid angle. Therefore, a reflective surface 408, as shown in FIG. 4, may have a curvature designed to receive missed scattered light 412 scattered outside of the numerical aperture of the spectrometer 404 in all directions and to redirect the missed scattered light 412 back towards the sample as reflected scattered light 414 to produce redirected scattered light, at least a portion of which may be coupled into the spectrometer 404 as indirectly coupled redirected scattered light 416. The reflective surface 408 may further have a hole 418 therein for coupling of scattered light including the directly coupled scattered light 410 and the indirectly coupled redirected scattered light 416 into the spectrometer 404. In the example shown in FIG. 4, the reflective surface 408 is a sphere. By using a spherically shaped reflective surface 408 to redirect missed scattered light from the sample 406 in all directions, the coupled spot size may be increased, thus effectively achieving a larger field of view of the spectrometer 404. In addition, using a spherical reflecting surface 408 may result in an increase in coupled power and improved sample representation.

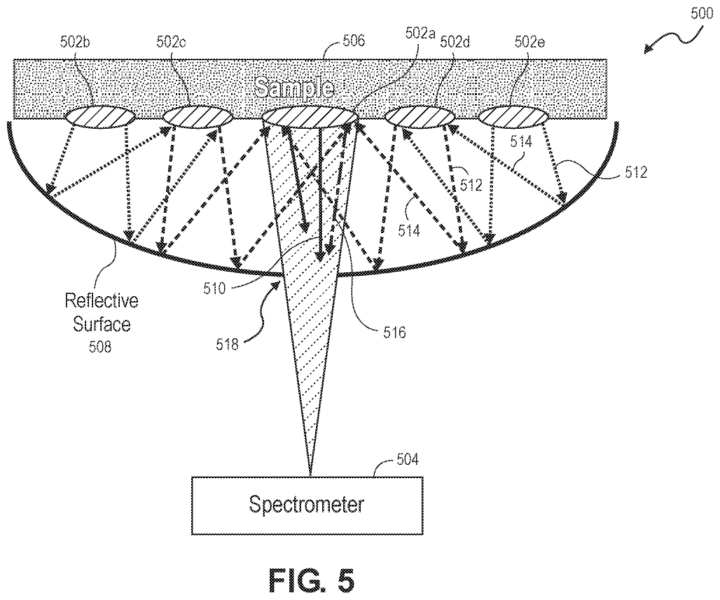

FIG. 5 is a diagram illustrating another example of an optical device with light redirection for spectrometer collection according to some aspects. The optical device 500 includes a spectrometer 504 configured to receive coupled light from a sample 506 at an input thereof and to obtain a spectrum of the sample 506 based on the coupled light. The spectrometer 504 may be, for example, a Fourier Transform infrared (FTIR) spectrometer operating in a diffuse reflectance mode. In the example shown in FIG. 5, light is incident on a plurality of illuminated spots 502a-502e on the sample 506, where at least one of the spots (e.g., spots 502b-502e) has a sample area outside or at least partially outside of a field of view of the spectrometer 504. In this example, scattered light scattered from a spot (e.g., spot 502a) within the acceptance numerical aperture of the spectrometer 504 may be directly coupled into the spectrometer 504 as directly coupled scattered light 510.

Light scattered from other spots (e.g., spots 502b-502e) on the sample 506 may be trapped between the sample 506 and a reflective surface 508 for redirection of the scattered light towards a spot (e.g., spot 502a) on the sample 506 within the field of view of the spectrometer 504. For example, the reflective surface 508 may have a curvature configured to collect scattered light (e.g., scattered light 512) from an illuminated spot (e.g., spot 502d) outside the field of view of the spectrometer 504 and to redirect (reflect) the scattered light as reflected scattered light 514 to another spot (e.g., spot 502a) on the sample 506 within the field of view of the spectrometer 504, where the light is scattered for a second time to produce redirected scattered light that may be coupled into the spectrometer 504 as indirectly coupled redirected scattered light 516. In this example, the first spot 502d and the second spot 502a form an extended spot area on the sample 506. The reflective surface 508 may further have a hole 518 therein for coupling of scattered light including the directly coupled scattered light 510 and the indirectly coupled redirected scattered light 516 into the spectrometer 504.

In some examples, light may be redirected multiple times. For example, the reflective surface 508 may be configured to receive scattered light (e.g., scattered light 512) from a first illuminated spot (e.g., spot 502e) outside the field of view of the spectrometer 504 and to redirect (reflect) the scattered light as reflected scattered light 514 to a second spot (e.g., spot 502d) on the sample 506 that is also outside (or partially outside) the field of view of the spectrometer 504. The light may then be scattered for a second time to produce redirected scattered light 512 that may be redirected again by the reflective surface 508 to a third spot (e.g., spot 502a) within the field of view of the spectrometer 504, where the light is scattered again for a third time to produce redirected scattered light, at least a portion of which may be coupled into the spectrometer 504 as indirectly coupled redirected scattered light 516.

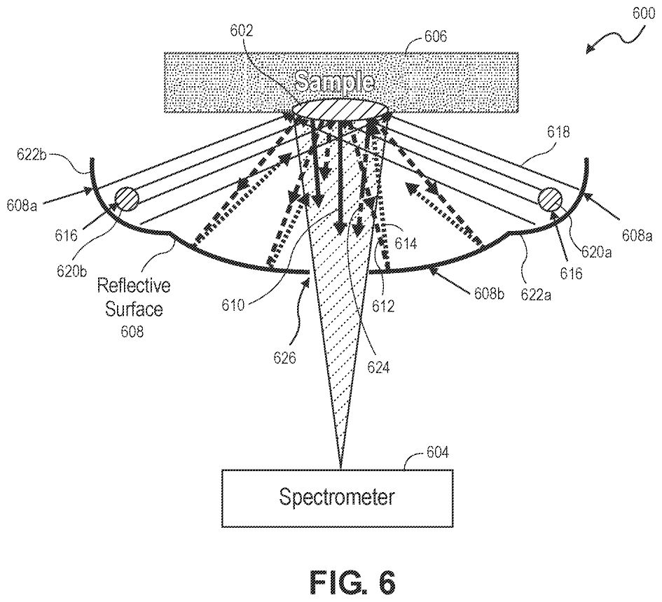

FIG. 6 is a diagram illustrating another example of an optical device with light redirection for spectrometer collection according to some aspects. The optical device 600 includes a spectrometer 604 configured to receive coupled light from a sample 606 at an input thereof and to obtain a spectrum of the sample 606 based on the coupled light. The spectrometer 604 may be, for example, a Fourier Transform infrared (FTIR) spectrometer operating in a diffuse reflectance mode. In the example shown in FIG. 6, the optical device 600 further includes a reflective surface 608 and an illumination system 616 (e.g., one or more light sources 620a and 620b) positioned between the reflective surface 608 and the sample 606. The illumination system 616 is configured to illuminate a spot 602 on the sample 606 with input light 618 either directly and/or via reflection of the input light 618 from the reflective surface 608. The input light 618 may then be reflected and scattered from the spot 602 on the sample 606 to produce scattered light. The scattered light within the acceptance numerical aperture of the spectrometer 604 may be directly coupled into the spectrometer 604 as directly coupled scattered light 610.

The reflective surface 608 may include a first section 608a adjacent to the illumination system 616 having a first curvature configured to couple the input light 618 to the spot 602 on the sample 606 and a second section 608b having a second curvature different from the first curvature and configured to collect scattered light (e.g., scattered light 612) from the illuminated spot 602 and to redirect (reflect) the scattered light as reflected scattered light 614 to the spot 602 on the sample 606, thereby increasing the effective spot size of the spot 602 (e.g., as a result of different angles of light being incident on the sample). Here, the light is scattered for a second time to produce redirected scattered light that may be coupled into the spectrometer 604 as indirectly coupled redirected scattered light 624 to increase the illuminated power in the throughput-limited effective area that gets coupled into the spectrometer 604. In this example, the first section 608a includes two outside sections 622a and 622b and the illumination system includes two light sources 620a and 620b, each positioned adjacent to one of the outside sections 622a and 622b. The reflective surface 608 may further have a hole 626 therein for coupling of scattered light including the directly coupled scattered light 610 and the indirectly coupled redirected scattered light 624 into the spectrometer 604. It should be understood that the present disclosure is not limited to any particular number or configuration of the light sources 620a and 620b or the number or configuration of the outside sections 622a and 622b. For example, the position and number of light sources 620a and 620b and the outside sections 622a and 622b may vary, based on the configuration of the optical device 600.

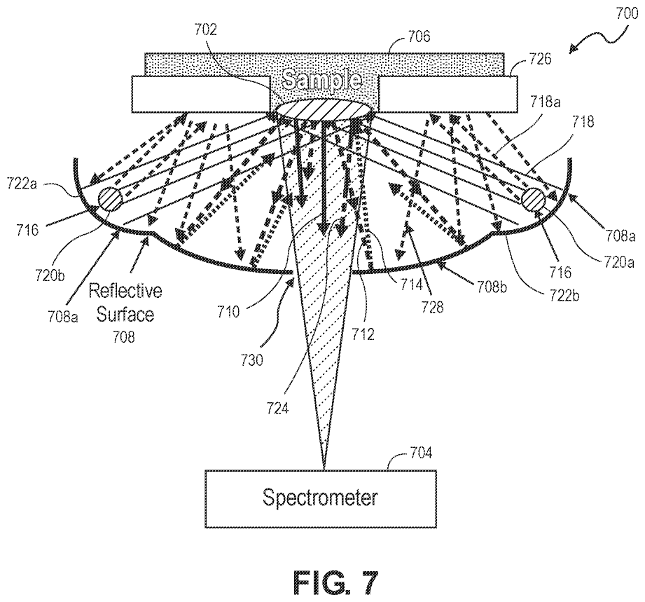

FIG. 7 is a diagram illustrating another example of an optical device with light redirection for spectrometer collection according to some aspects. The optical device 700 includes a spectrometer 704 configured to receive coupled light from a sample 706 at an input thereof and to obtain a spectrum of the sample 706 based on the coupled light. The spectrometer 704 may be, for example, a Fourier Transform infrared (FTIR) spectrometer operating in a diffuse reflectance mode. In the example shown in FIG. 7, the optical device 700 further includes a reflective surface 708, an illumination system 716 (e.g., one or more light sources 720a and 720b) positioned between the reflective surface 708 and the sample 706, and a diffuse reflective material 726 on each side of the sample 706. The illumination system 716 is configured to illuminate a spot 702 on the sample 706 with input light 718 either directly and/or via reflection of the input light 718 from the reflective surface 708. The input light 718 may then be reflected and scattered from the spot 702 on the sample 706 to produce scattered light. The scattered light within the acceptance numerical aperture of the spectrometer 704 may be directly coupled into the spectrometer 704 as directly coupled scattered light 710.

The reflective surface 708 may include a first section 708a adjacent to the illumination system 716 having a first curvature configured to couple the input light 718 to the spot 702 on the sample 706 and a second section 708b having a second curvature different from the first curvature and configured to collect scattered light (e.g., scattered light 712) from the illuminated spot 702 and to redirect (reflect) the scattered light as reflected scattered light 714 to the spot 702 on the sample 706. Here, the light is scattered for a second time to produce redirected scattered light that may be coupled into the spectrometer 704 as indirectly coupled redirected scattered light 724 to increase the effective spot size of the spot 702 (e.g., as a result of different angles of light being incident on the sample) and to increase the illuminated power in the throughput effective area coupled into the spectrometer 704. In this example, the first section 708a includes two outside sections 722a and 722b and the illumination system includes two light sources 720a and 720b, each positioned adjacent to one of the outside sections 722a and 722b. The reflective surface 708 may further have a hole 730 therein for coupling of scattered light including the directly coupled scattered light 710 and the indirectly coupled redirected scattered light 724 into the spectrometer 704. It should be understood that the present disclosure is not limited to any particular number or configuration of the light sources 720a and 720b or the number or configuration of the outside sections 722a and 722b. For example, the position and number of light sources 720a and 720b and the outside sections 722a and 722b may vary, based on the configuration of the optical device 700.

In addition, in the example shown in FIG. 7, the diffuse reflective material 726 is configured to reflect at least a portion of the input light 718a radiated from the light sources 720a and 720b to the sides of the sample 706 back towards the reflective surface 708 as reflected light 728. This reflected light 728 may then be redirected by the reflective surface 708 (e.g., via the first section 708a or the second section 708b) to the spot 702 on the sample 706 to produce additional redirected scattered light that may be coupled into the spectrometer 704, thus increasing the coupled light to the spectrometer 704. In some examples, the diffuse reflective material 726 is a highly diffuse reflective material, such as Spectralon/polytetrafluoroethylene (PTFE).

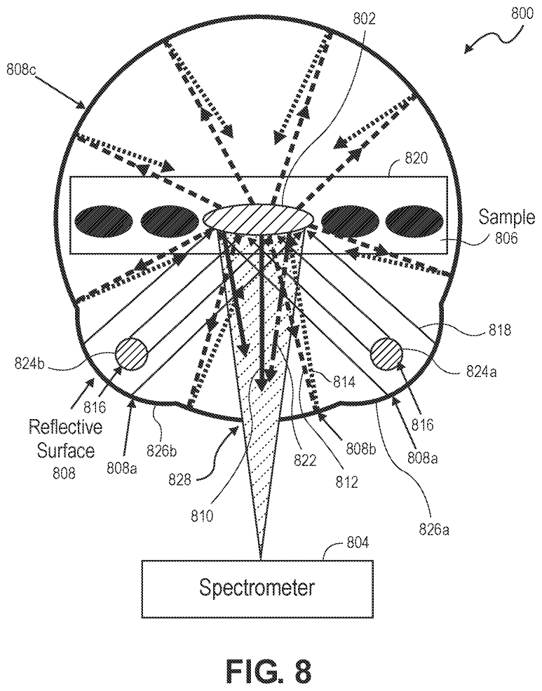

FIG. 8 is a diagram illustrating another example of an optical device with light redirection for spectrometer collection according to some aspects. The optical device 800 includes a spectrometer 804 configured to receive coupled light from a sample 806 at an input thereof and to obtain a spectrum of the sample 806 based on the coupled light. The spectrometer 804 may be, for example, a Fourier Transform infrared (FTIR) spectrometer operating in a diffuse reflectance mode. In the example shown in FIG. 8, the optical device 800 further includes a reflective surface 808 and an illumination system 816 (e.g., one or more light sources 824a and 824b) positioned between the reflective surface 808 and the sample 806. The illumination system 816 is configured to illuminate a spot 802 on the sample 806 with input light 818 either directly and/or via reflection of the input light 818 from the reflective surface 808. The input light 818 may then be reflected and scattered from the spot 802 on the sample 806 to produce scattered light. The scattered light within the acceptance numerical aperture of the spectrometer 804 may be directly coupled into the spectrometer 804 as directly coupled scattered light 810.

In addition, in the example shown in FIG. 8, the reflective surface 808 may be designed to receive missed scattered light 812 scattered outside of the numerical aperture of the spectrometer 804 in all directions and to redirect the missed scattered light 812 back towards the sample as reflected scattered light 814 to produce redirected scattered light, at least a portion of which may be coupled into the spectrometer 804 as indirectly coupled redirected scattered light 822. In the example shown in FIG. 8, the reflective surface 808 completely surrounds the sample 806 on all sides and includes a first section 808a, a second section 808b and a third section 808c.

The first section 808a is adjacent to the illumination system 816 and has a first curvature configured to couple the input light 818 to the spot 802 on the sample 806. For example, the first section 808a includes two outside sections 826a and 826b and the illumination system includes two light sources 824a and 824b, each positioned adjacent to one of the outside sections 826a and 826b (e.g., between the reflective surface 808 of the outside sections 826a and 826b and the sample 806). The second section 808b is positioned between the two outside sections 826a and 826b of the first section 808a in front of the sample 806 (e.g., on a same side as the spectrometer 804) and has a second curvature different from the first curvature. The third section 808c is positioned between the two outside sections 826a and 826b behind the sample 806 (e.g., on an opposite side as the spectrometer 804) and has a third curvature different from the first and second curvatures.

The second section 808b and third section 808c are each configured to collect scattered light (e.g., scattered light 812) from the spot 802 on the sample 806 or from other spots on the sample 806 (e.g., other spots radiated by the light sources 824a and 824b) in all directions and to redirect (reflect) the scattered light as reflected light 814 to the spot 802 on the sample 806 to increase the effective spot size of the spot 802 (e.g., as a result of different angles of light being incident on the sample). Here, the light is scattered for a second time to produce redirected scattered light that may be coupled into the spectrometer 804 as indirectly coupled redirected scattered light 822. The reflective surface 808 may further have a hole 828 therein for coupling of scattered light including the directly coupled scattered light 810 and the indirectly coupled redirected scattered light 822 into the spectrometer 804. It should be understood that the present disclosure is not limited to any particular number or configuration of the light sources 824a and 824b or the number or configuration of the outside sections 826a and 826b. For example, the position and number of light sources 824a and 824b and the outside sections 826a and 826b may vary, based on the configuration of the optical device 800. Moreover, the shape and curvature of the sections 808a, 808b, and 808c of the reflective surface 808 may vary depending on the desired coupling into the spectrometer 804.

The optical device 800 may further include a sample holder 820 configured to hold the sample 806. In the example shown in FIG. 8, the sample holder 820 may extend in a first direction (e.g., horizontal) that is parallel with respect to a plane of a substrate including the spectrometer 804.

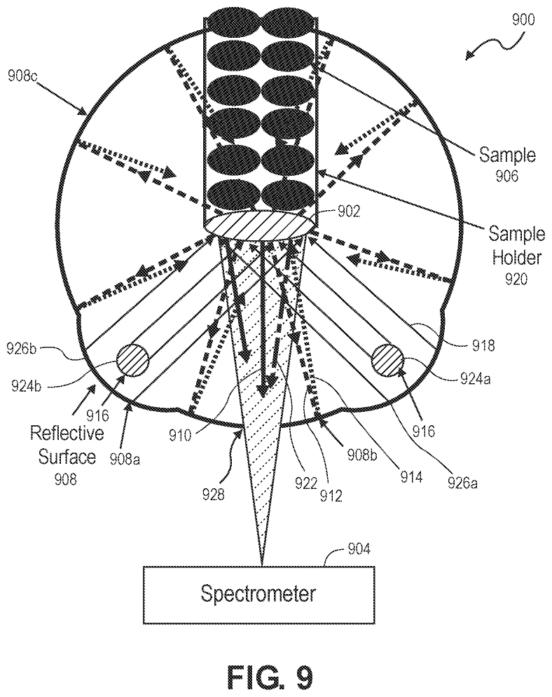

FIG. 9 is a diagram illustrating another example of an optical device with light redirection for spectrometer collection according to some aspects. The optical device 900 includes a spectrometer 904 configured to receive coupled light from a sample 906 at an input thereof and to obtain a spectrum of the sample 906 based on the coupled light. The spectrometer 904 may be, for example, a Fourier Transform infrared (FTIR) spectrometer operating in a diffuse reflectance mode. In the example shown in FIG. 9, the optical device 900 further includes a reflective surface 908 and an illumination system 916 (e.g., one or more light sources 924a and 924b) positioned between the reflective surface 908 and the sample 906 similar to that shown in FIG. 8. For example, the illumination system 916 is configured to illuminate a spot 902 on the sample 906 with input light 918 either directly and/or via reflection of the input light 918 from the reflective surface 908. The input light 918 may then be reflected and scattered from the spot 902 on the sample 906 to produce scattered light. The scattered light within the acceptance numerical aperture of the spectrometer 904 may be directly coupled into the spectrometer 904 as directly coupled scattered light 910.

In addition, in the example shown in FIG. 9, the reflective surface 908 may be designed to receive missed scattered light 912 scattered outside of the numerical aperture of the spectrometer 904 in all directions and to redirect the missed scattered light 912 back towards the sample as reflected scattered light 914 to produce redirected scattered light, at least a portion of which may be coupled into the spectrometer 904 as indirectly coupled redirected scattered light 922. In the example shown in FIG. 9, the reflective surface 908 completely surrounds the sample 906 on all sides and includes a first section 908a, a second section 908b and a third section 908c.

The first section 908a is adjacent to the illumination system 916 and has a first curvature configured to couple the input light 918 to the spot 902 on the sample 906. For example, the first section 908a includes two outside sections 926a and 926b and the illumination system includes two light sources 924a and 924b, each positioned adjacent to one of the outside sections 926a and 926b (e.g., between the reflective surface 908 of the outside sections 926a and 926b and the sample 906). The second section 908b is positioned between the two outside sections 926a and 926b of the first section 908a in front of the sample 906 (e.g., on a same side as the spectrometer 904) and has a second curvature different from the first curvature. The third section 908c is positioned between the two outside sections 926a and 926b on the sides of the sample 906 (e.g., on an opposite side as the spectrometer 904) and has a third curvature different from the first and second curvatures.

The second section 908b and third section 908c are each configured to collect scattered light (e.g., scattered light 912) from the spot 902 on the sample 906 or from other spots on the sample 906 (e.g., other spots radiated by the light sources 924a and 924b or by reflected light) in all directions and to redirect (reflect) the scattered light as reflected light 914 to the spot 902 on the sample 906 to effectively increase the spot size of the spot 902 (e.g., as a result of different angles of light being incident on the sample). Here, the light is scattered for a second time to produce redirected scattered light that may be coupled into the spectrometer 904 as indirectly coupled redirected scattered light 922. The reflective surface 908 may further have a hole 928 therein for coupling of scattered light including the directly coupled scattered light 910 and the indirectly coupled redirected scattered light 922 into the spectrometer 904. It should be understood that the present disclosure is not limited to any particular number or configuration of the light sources 924a and 924b or the number or configuration of the outside sections 926a and 926b. For example, the position and number of light sources 924a and 924b and the outside sections 926a and 926b may vary, based on the configuration of the optical device 900. Moreover, the shape and curvature of the sections 908a, 908b, and 908c of the reflective surface 908 may vary depending on the desired coupling into the spectrometer 904.

The optical device 900 may further include a sample holder 920 configured to hold the sample 906. In the example shown in FIG. 9, the sample holder 920 may extend in a second direction (e.g., vertical) that is perpendicular with respect to a plane of a substrate including the spectrometer 904. In this example, the second direction of the sample holder 920 is further perpendicular to the first direction of the sample holder 820 shown in FIG. 8. It should be understood that the sample holder 920 can extend in any suitable direction, depending on the configuration of the light sources 924a and 924b, the spectrometer 904 and the reflective surface 908.

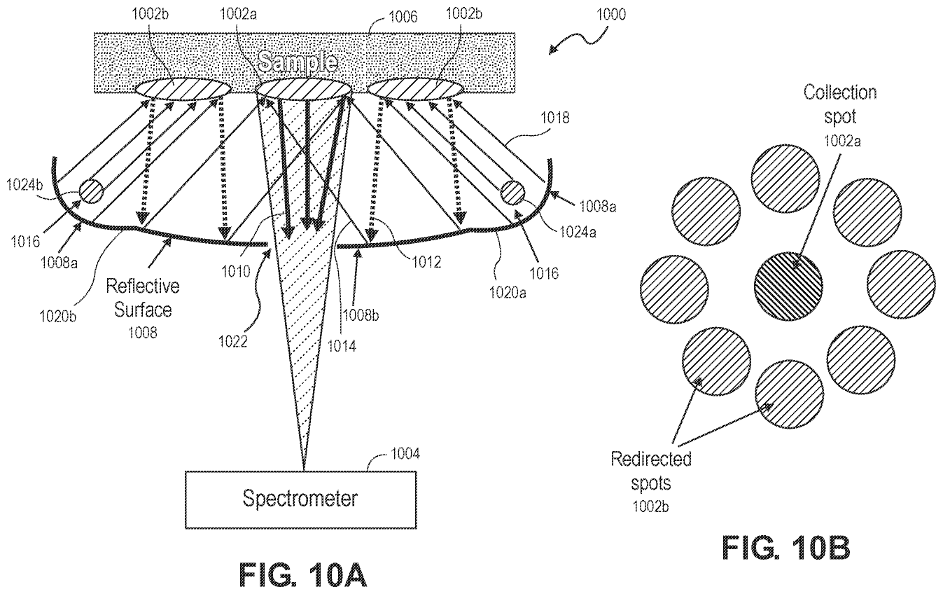

FIGS. 10A and 10B are diagrams illustrating another example of an optical device with light redirection for spectrometer collection according to some aspects. The optical device 1000 includes a spectrometer 1004 configured to receive coupled light from a sample 1006 at an input thereof and to obtain a spectrum of the sample 1006 based on the coupled light. The spectrometer 1004 may be, for example, a Fourier Transform infrared (FTIR) spectrometer operating in a diffuse reflectance mode. In the example shown in FIG. 10, the optical device 1000 further includes a reflective surface 1008 and an illumination system 1016 (e.g., one or more light sources 1024a and 1024b) positioned between the reflective surface 1008 and the sample 1006.

In the example shown in FIGS. 10A and 10B, a multi-bounce, multiple-incidence configuration is depicted in which light hits the sample 1006 multiple times in different spatial area/spots (e.g., collection spot 1002a and redirected spots 1002b). For example, input light 1018 from each light source 1024a and 1024b of the illumination system 1016 is configured to illuminate a respective redirected spot 1002b on the sample 1006 outside or at least partially outside of a field of view of the spectrometer 1004 either directly and/or via reflection of the input light 1018 from the reflective surface 1008. Scattered light from the redirected spots 1002b may then be redirected towards the collection spot 1002a on the sample using the reflective surface 1008.

For example, the reflective surface 1008 may include a first section 1008a adjacent to the illumination system 1016 having a first curvature configured to couple the input light 1018 to the respective redirected spot 1002b on the sample 1006. In this example, the first section 1008a includes two outside sections 1020a and 1020b and the illumination system includes two light sources 1024a and 1024b, each positioned adjacent to one of the outside sections 1020a and 1020b. The reflective surface 1008 may further include a second section 1008b having a second curvature different from the first curvature and configured to collect scattered light (e.g., scattered light 1012) from the illuminated redirected spots 1002b outside or partially outside the field of view of the spectrometer 1004 and to redirect (reflect) the scattered light as reflected scattered light 1014 to the collection spot 1002a (e.g., a collection area) on the sample 1006 that is within the field of view of the spectrometer 1004. Here, the light is scattered for a second time to produce redirected scattered light 1010 that may be coupled into the spectrometer 1004. In this example, the redirected scattered light 1010 may correspond to the directly coupled scattered light. The reflective surface 1008 may further have a hole 1022 therein for coupling of scattered light 1010 into the spectrometer 1004.

Missed light scattered outside the acceptance numerical aperture of the spectrometer 1004 may further be redirected again towards the collection spot 1002a on the sample 1006 via the second section 1008b of the reflective surface 1008, and scattered a third time to produce additional redirected scattered light 1010, at least a portion of which may be coupled into the spectrometer 1004 as indirectly coupled redirected scattered light. It should be understood that the number of bounces may be increased, depending on the configuration of the optical device 1000. For example, scattered light from redirected spots 1002b may be directed to additional spots (not shown) on the sample 1006 outside or partially outside the field of view of the spectrometer 1004 prior to being directed to the collection spot 1002a within the field of view of the spectrometer 1004. The multiple-bounce configuration shown in FIG. 10 results in an increase in the effective spot scanned, resulting in a large spot size seen by the spectrometer 1004. For example, the collection spot 1002a and redirected spots 1002b can form an extended spot area on the sample 1006.

In some examples, the measured power spectral density PSD by the spectrometer 1004, in presence of the sample, Sₛ, is given by:

Sₛ=Rₛ²Sₒ, (Equation 1)

where Sₒ is the reference PSD in presence of an ideal diffuse reflectance (e.g., Spectralon) and Rₛ is the sample reflectance. The squaring of the Rₛ is based on the light interaction with the sample twice before being coupled to the spectrometer (as shown in the configuration of FIG. 10A). Then, Rₛ can be extracted from taking the square root of the apparent reflectance Rₐ measured by the spectrometer:

$${R}_{s} = \sqrt{{R}_{a}} = \sqrt{\frac{{S}_{s}}{{S}_{o}}} \qquad ( Equation 2 )$$

For non-homogeneous samples where the spectral characteristics may differ depending on measurement location on the sample, the light scattered from the different spots may experience different reflectance. Accordingly, in the configuration shown in FIG. 10A, we can express the extracted reflectance by the spectrometer R_{s,NH} as:

$${R}_{s , NH} = \sqrt{{R}_{a}} = \sqrt{\frac{{S}_{s}}{{S}_{o}}} = \sqrt{\frac{1}{2} ( {R}_{s 1} + {R}_{s 2} ) {R}_{s 0}} . \qquad ( Equation 3 )$$

where Rₛ₁ is the sample reflectance from the right-hand spot, Rₛ₂ is the sample reflectance from the left-hand spot, and Rₛ₀ is the sample reflectance from the middle spot, as shown in FIG. 10A.

Thus, it is clear that the extracted reflectance is the geometrical mean of middle-region reflectance (e.g., collection spot 1002a) and the mathematical mean of the left and right regions (e.g., redirected spots 1002b). Assuming random noise effect due to non-homogeneity across the sample, the reflectance of each specific spot can be expressed as:

Rₛₖ=R_{s,H}+nₛₖ, (Equation 4)

where Rₛₖ represents the reflectance from spot k, R_{s,H} is the homogenous reflectance of the sample, and nₛₖ is the reflectance noise due to non-homogeneity from different regions/spots, the extracted sample reflectance of a non-homogenous sample, R_{s,NH}, can be expressed as:

$${R}_{s , NH} = \sqrt{\frac{1}{2} ( 2 {R}_{s , H} + {n}_{s 1} + {n}_{s 2} ) ( {R}_{s , H} + {n}_{s 0} )}$$

$${R}_{s , NH} = {R}_{s , H} \sqrt{( 1 + ( {n}_{s 0} + \frac{{n}_{s 1} + {n}_{s 2}}{2} ) \frac{1}{{R}_{s , H}} + {n}_{s 0} \frac{{n}_{s 1} + {n}_{s 2}}{2} \frac{1}{{R}_{s , H}^{2}} )} .$$

### (Equation 5)

For R_{s,H}>>nₛ, the third term under the square root of 1/R_{s,H}² can be ignored, and the expression can be approximated as:

$${R}_{s , NH} \approx {R}_{s , H} ( 1 + \frac{1}{2} \sqrt{\frac{3}{2}} \frac{{n}_{s}}{{R}_{s , H}} ) = {R}_{s , H} + \sqrt{\frac{3}{8}} {n}_{s} . \qquad ( Equation 6 )$$

The above illustrates that noise due to sample non-homogeneity is reduced by around 39%, which is close to the case of tripling the spot size, as if non-homogeneity noise is averaged from three different spots, leading to noise degradation by around 42%. Extending this concept to M light sources illuminating the sample at M distinct spots around the main collection region (collection spot), which is re-directed back to the main collection region, the extracted reflectance is expressed as:

$${R}_{s , NH} = \sqrt{\frac{1}{2} ( {R}_{s 1} + {R}_{s 2} … + {R}_{s M} ) {R}_{s 0}} \qquad ( Equation 7 )$$

$${R}_{s , NH} \approx {R}_{s , H} + \frac{1}{2} \sqrt{\frac{N + 1}{N}} {n}_{s} .$$

As indicated in the above equation, the expected non-homogeneity noise reduction is saturating at 50%, and therefore, increasing the number of bulbs and consequently illumination spots mainly provides an increase in the collected signal level.

In some examples, the spectrometer signal to noise ratio (SNR) can be analyzed, considering the spectrometer system noise apart from noise due to sample non-homogeneity, and coupled signal level. The multiple-incidence configuration shown in FIG. 10AError! Reference source not found. can then be compared to the case of a direct collection of a spot with three times larger diameter 3Ds, assuming the same light sources are used. For the direct collection case, according to throughput limitation, coupling efficiency is inversely proportional to spot area, and therefore, the coupling efficiency is reduced nine times due to three times increase in diameter.

For the multiple-incidence configuration shown in FIG. 10A, the coupling efficiency is mainly determined by the size of the collection spot 1002a regardless of the number of the redirected spots 1002b. However, due to multiple incidences on the sample, the signal level is reduced more than the normal case by the extra sample reflectance response. In this example, one-incidence sample reflectance may be extracted by taking the square root of the measured apparent reflectance (in case of two incidences), as explained above. Then, the SNR of extracted reflectance is 2Rₛ that of the normal case of one incidence on the sample, where system noise is reduced two times by taking the square root of the signal. Therefore, if Rₛ=0.5, the same SNR may be achieved as the one-incidence and D collection diameter spot case, but nine times the SNR of the 3D collection diameter. In summary, using this configuration can further enhance the spectrometer SNR assuming for the same spectrometer etendue.

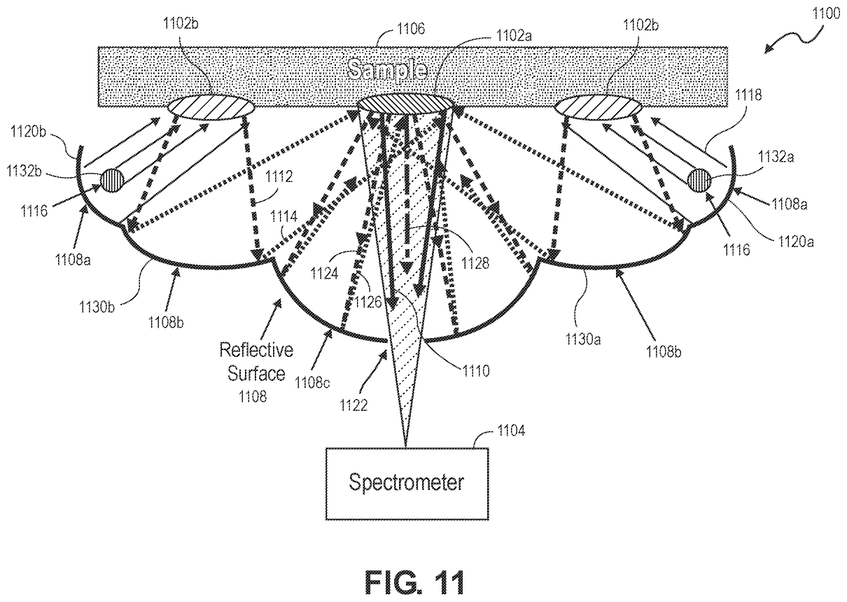

FIG. 11 is a diagram illustrating another example of an optical device with light redirection for spectrometer collection according to some aspects. The optical device 1100 includes a spectrometer 1104 configured to receive coupled light from a sample 1106 at an input thereof and to obtain a spectrum of the sample 1106 based on the coupled light. The spectrometer 1104 may be, for example, a Fourier Transform infrared (FTIR) spectrometer operating in a diffuse reflectance mode. In the example shown in FIG. 11, the optical device 1100 further includes a reflective surface 1108 and an illumination system 1116 (e.g., one or more light sources 1132a and 1132b) positioned between the reflective surface 1108 and the sample 1106.

The example shown in FIG. 11 is another example of a multi-bounce, multiple-incidence configuration in which light hits the sample 1106 multiple times in different spatial area/spots (e.g., collection spot 1102a and redirected spots 1102b). For example, input light 1118 from each light source 1132a and 1132b of the illumination system 1116 is configured to illuminate a respective redirected spot 1102b on the sample 1106 outside or at least partially outside of a field of view of the spectrometer 1104 either directly and/or via reflection of the input light 1118 from the reflective surface 1108. Scattered light from the redirected spots 1102b may then be redirected towards the collection spot 1102a on the sample using the reflective surface 1108.

For example, the reflective surface 1108 may include a first section 1108a adjacent to the illumination system 1116 having a first curvature configured to couple the input light 1118 to the respective redirected spot 1102b on the sample 1106. In this example, the first section 1108a includes two outside sections 1120a and 1120b and the illumination system includes two light sources 1132a and 1132b, each positioned adjacent to one of the outside sections 1120a and 1120b. The reflective surface 1108 may further include a second section 1108b having a second curvature different from the first curvature and configured to collect scattered light (e.g., scattered light 1112) from the illuminated redirected spots 1102b outside or partially outside the field of view of the spectrometer 1104 and to redirect (reflect) the scattered light as reflected scattered light 1114 to the collection spot 1102a (e.g., a collection area) on the sample 1106 that is within the field of view of the spectrometer 1104. Here, the light is scattered for a second time to produce redirected scattered light 1110 that may be coupled into the spectrometer 1104. In this example, the redirected scattered light 1110 may correspond to the directly coupled scattered light. The reflective surface 1108 may further have a hole 1122 therein for coupling of scattered light 1110 into the spectrometer 1104.

The reflective surface 1108 may further include a third section 1108c (e.g., an inside section) having a third curvature different than the first curvature and the second curvature and configured to collect missed scattered light 1124 outside the acceptance numerical aperture of the spectrometer 1104 and to redirect the missed scattered light 1124 again towards the collection spot 1102a on the sample 1106 as missed reflected light 1126. Here, the missed reflected light may be scattered a third time to produce additional redirected scattered light 1128, at least a portion of which may be coupled into the spectrometer 1104 as indirectly coupled redirected scattered light. As shown in FIG. 11, the second section 1108b may include two additional sections 1130a and 1130b, each between a respective one of the outside sections 1120a and 1120b and the inside section 1108c. It should be understood that the number of bounces may be increased, depending on the configuration of the optical device 1100. For example, scattered light from redirected spots 1102b may be directed to additional spots (not shown) on the sample 1106 outside or partially outside the field of view of the spectrometer 1104 prior to being directed to the collection spot 1102a within the field of view of the spectrometer 1104. The multiple-bounce configuration shown in FIG. 11 results in an increase in the effective spot scanned, resulting in a large spot size seen by the spectrometer 1104. For example, the collection spot 1102a and redirected spots 1102b can form an extended spot area on the sample 1106.

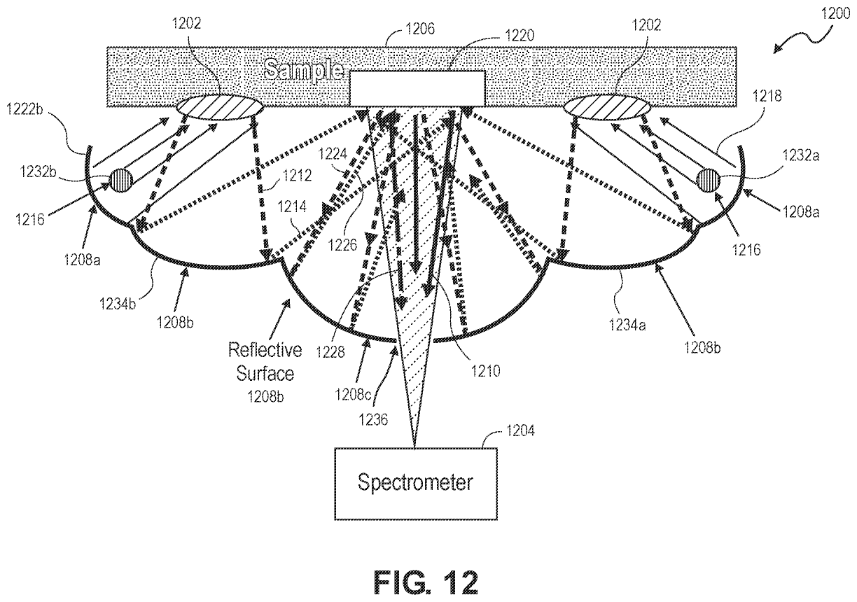

FIG. 12 is a diagram illustrating another example of an optical device with light redirection for spectrometer collection according to some aspects. The optical device 1200 includes a spectrometer 1204 configured to receive coupled light from a sample 1206 at an input thereof and to obtain a spectrum of the sample 1206 based on the coupled light. The spectrometer 1204 may be, for example, a Fourier Transform infrared (FTIR) spectrometer operating in a diffuse reflectance mode. In the example shown in FIG. 12, the optical device 1200 further includes a reflective surface 1208 and an illumination system 1216 (e.g., one or more light sources 1232a and 1232b) positioned between the reflective surface 1208 and the sample 1206.

The example shown in FIG. 12 is another example of a multi-bounce, multiple-incidence configuration in which light hits the sample 1206 multiple times in different spatial area/spots (e.g., redirected spots 1202 and a collection area 1220). In this example, the collection area 1220 is a diffuse reflective material, such as Spectralon/PTFE. For example, input light 1218 from each light source 1232a and 1232b of the illumination system 1216 is configured to illuminate a respective redirected spot 1202 on the sample 1206 outside or at least partially outside of a field of view of the spectrometer 1204 either directly and/or via reflection of the input light 1218 from the reflective surface 1208. Scattered light from the redirected spots 1202 may then be redirected towards the collection area 1220 on the sample using the reflective surface 1208.

For example, the reflective surface 1208 may include a first section 1208a adjacent to the illumination system 1216 having a first curvature configured to couple the input light 1218 to the respective redirected spot 1202 on the sample 1206. In this example, the first section 1208a includes two outside sections 1222a and 1222b and the illumination system includes two light sources 1232a and 1232b, each positioned adjacent to one of the outside sections 1222a and 1222b. The reflective surface 1208 may further include a second section 1208b having a second curvature different from the first curvature and configured to collect scattered light (e.g., scattered light 1212) from the illuminated redirected spots 1202 outside or partially outside the field of view of the spectrometer 1204 and to redirect (reflect) the scattered light as reflected scattered light 1214 to the collection area 1220 (e.g., diffuse reflective material) on the sample 1206 that is within the field of view of the spectrometer 1204. Here, the light is reflected to produce redirected scattered light 1210 that may be coupled into the spectrometer 1204. In this example, the redirected scattered light 1210 may correspond to the directly coupled scattered light. The reflective surface 1208 may further have a hole 1236 therein for coupling of scattered light 1210 into the spectrometer 1204.

The reflective surface 1208 may further include a third section 1208c (e.g., an inside section) having a third curvature different than the first curvature and the second curvature and configured to collect missed scattered light 1224 outside the acceptance numerical aperture of the spectrometer 1204 and to redirect the missed scattered light 1224 again towards the collection area 1220 on the sample 1206 as missed reflected light 1226. Here, the missed reflected light may be reflected to produce additional redirected scattered light 1228, at least a portion of which may be coupled into the spectrometer 1204 as indirectly coupled redirected scattered light. As shown in FIG. 12, the second section 1208b may include two additional sections 1234a and 1234b, each between a respective one of the outside sections 1222a and 1222b and the inside section 1208c. It should be understood that the number of bounces may be increased, depending on the configuration of the optical device 1200. For example, scattered light from redirected spots 1202 may be directed to additional spots (not shown) on the sample 1206 outside or partially outside the field of view of the spectrometer 1204 prior to being directed to the collection area 1220 within the field of view of the spectrometer 1204. The multiple-bounce configuration shown in FIG. 12 results in an increase in the effective spot scanned, resulting in a large spot size seen by the spectrometer 1204. For example, the redirected spots 1202 can form an extended spot area on the sample 1206.

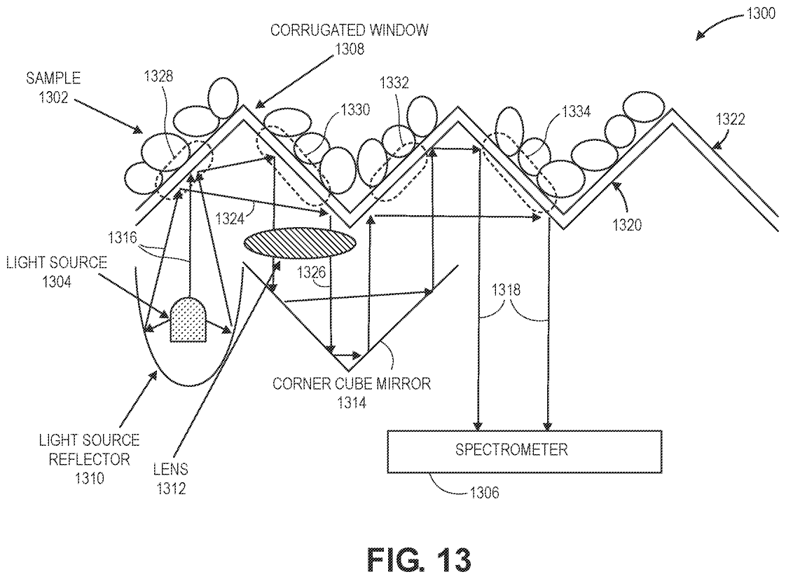

FIG. 13 is a diagram illustrating another example of an optical device with light redirection for spectrometer collection according to some aspects. The optical device 1300 includes a spectrometer 1306 configured to receive coupled light from a sample 1302 at an input thereof and to obtain a spectrum of the sample 1302 based on the coupled light. The spectrometer 1306 may be, for example, a Fourier Transform infrared (FTIR) spectrometer operating in a diffuse reflectance mode. In the example shown in FIG. 13, the optical device 1300 further includes a corrugated window 1308 (e.g., a transparent window) and an illumination system formed of a light source 1304 (e.g., a lamp with a surrounding light source reflector 1310). The light source 1304 (with surrounding light source reflector 1310) may be positioned opposite a first side 1320 of the corrugated window 1308 and the sample 1302 may be positioned on a second side 1322 of the corrugated window 1308 opposite the first side 1320 such that the corrugated window 1308 is positioned between the illumination system 1304/1310 and the sample 1302. In some examples, the corrugation in the corrugated window 1308 may be made comparable to the illumination spot diameter of the light source 1304. More specifically, half the corrugation period may be made approximately equal to the illumination spot diameter.

The light source 1304 is configured to illuminate the sample 1302 with input light 1316 via the corrugated window 1308. For example, the sample 1302 may be positioned on the outer half period of the corrugation making an incident angle of the input light 1316 centered around 45°. The input light 1316 incident on the sample 1302 will interact with the sample 1302 at spot 1328 to produce first scattered light 1324. Part of the first scattered light 1324 will hit the sample 1302 at spot 1330 placed on the other half of the first corrugation period and interact with the sample 1302 to produce second scattered light 1326. This second scattered light 1326 carries sample spectral information from the two halves of the corrugation period. A corner cube mirror 1314 may be positioned to receive the second scattered light 1326 after the two sample hits and redirect the light 1326 to the next corrugation period. In addition, one or more lenses (e.g., lens 1312) may be included and configured to increase the collection of the scattered light 1326 to the corner cube mirror 1314 and from the corner cube mirror 1314 to the sample 1302. The scattered light 1326 hitting the next corrugation period interacts with the sample 1302 at spot 1332 for the third time on the first half of this new period and for the fourth time on the second half at spot 1334 to produce redirected scattered light 1318. In this example, the redirected scattered light 1318 may include the directly coupled scattered light. The redirected scattered light 1318 may then be coupled into the spectrometer 1306. Each of spots 1328, 1330, 1332, and 113 collectively form an extended spot are on the sample 1302.

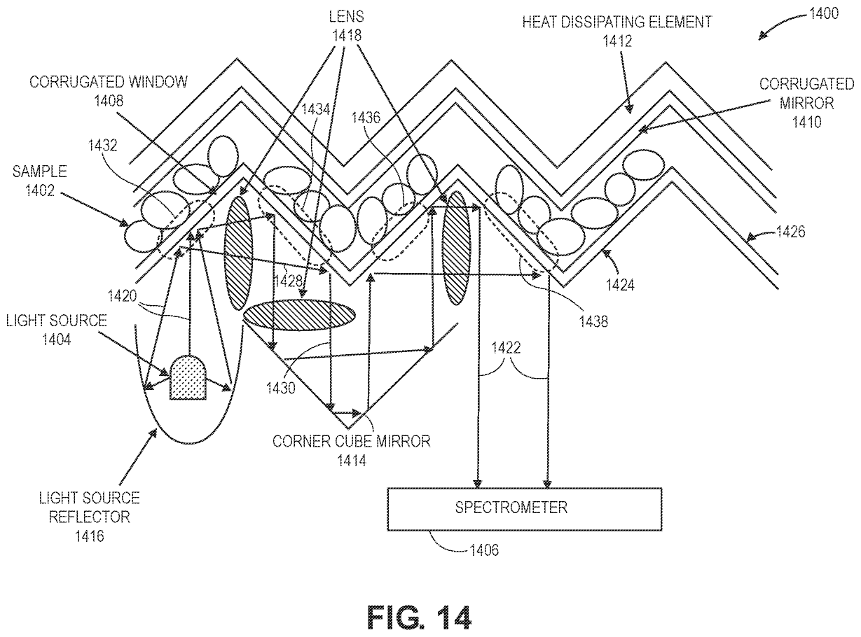

FIG. 14 is a diagram illustrating another example of an optical device with light redirection for spectrometer collection according to some aspects. The optical device 1400 includes a spectrometer 1406 configured to receive coupled light from a sample 1402 at an input thereof and to obtain a spectrum of the sample 1402 based on the coupled light. The spectrometer 1406 may be, for example, a Fourier Transform infrared (FTIR) spectrometer operating in a diffuse reflectance mode. In the example shown in FIG. 14, the optical device 1400 further includes a corrugated window 1408 and an illumination system formed of a light source 1404 (e.g., a lamp with a surrounding light source reflector 1416). Similar to the configuration shown in FIG. 13, the light source 1404 (with surrounding light source reflector 1416) may be positioned opposite a first side 1424 of the corrugated window 1408 and the sample 1402 may be positioned on a second side 1426 of the corrugated window 1408 opposite the first side 1424 such that the corrugated window 1408 is positioned between the illumination system 1404/1416 and the sample 1402.

In addition, similar to the configuration shown in FIG. 13, the light source 1404 is configured to illuminate the sample 1402 with input light 1420 via the corrugated window 1408. For example, the sample 1402 may be positioned on the outer half period of the corrugation making an incident angle of the input light 1420 centered around 45°. The input light 1420 incident on the sample 1402 will interact with the sample 1402 at spot 1432 to produce first scattered light 1428. Part of the first scattered light 1428 will hit the sample 1402 placed on the other half of the first corrugation period and interact with the sample 1402 at spot 1434 to produce second scattered light 1430. This second scattered light 1430 carries sample spectral information from the two halves of the corrugation period. A corner cube mirror 1414 may be positioned to receive the second scattered light 1430 after the two sample hits and redirect the light 1430 to the next corrugation period. In addition, one or more lenses 1418 may be included and configured to increase the collection of the scattered light 1430 to the corner cube mirror 1414 and from the corner cube mirror 1414 to the sample 1402. The scattered light 1430 hitting the next corrugation period interacts with the sample 1402 at spot 1436 for the third time on the first half of this new period and for the fourth time at spot 1438 on the second half to produce redirected scattered light 1422. In this example, the redirected scattered light 1422 may include the directly coupled scattered light. The redirected scattered light 1422 may then be coupled into the spectrometer 1406. Spots 1432, 1434, 1436, and 1438 collectively form an extended spot area on the sample 1402.

In addition, in the example shown in FIG. 14, a corrugated mirror 1410 may be positioned on top of the sample 1402, such that the sample 1402 is sandwiched between the corrugated window 1408 the corrugated mirror 1410. In addition, a heat dissipating element 1412 (e.g., a passive or active cooling system) may be attached to the corrugated mirror 1410 on the top side thereof. In some examples, the corrugated mirror 1410 may be a metallic mirror to enhance the heat conduction and reduce the overall temperature of the sample 1402. In this configuration, higher illumination intensities can be used without burning the sample 1402 since it will be cooled by the heat dissipating element 1412. Furthermore, this can help limit the rise of the temperature of the sample 1402 which usually affects the measured spectral features. This can enhance the measurement accuracy and reduce the errors due to temperature variations. In addition, the corrugated mirror 1410 can be configured to redirect the light that leaks between the sample grains back to the lower (first) side 1424 of the corrugated window 1408. Part of this redirected light can be collected by the corner cube mirror 1414 and interact with the sample 1402 in the next corrugation period, thus increasing the total efficiency of the system.

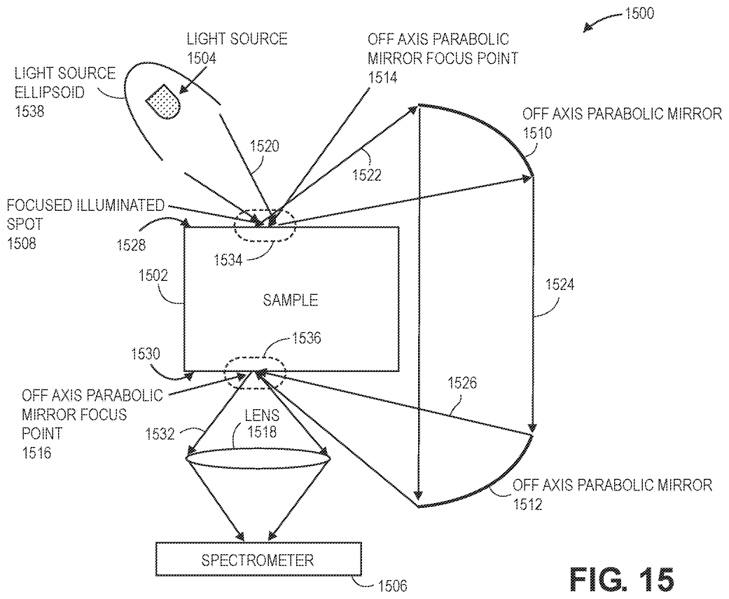

FIG. 15 is a diagram illustrating another example of an optical device with light redirection for spectrometer collection according to some aspects. The optical device 1500 includes a spectrometer 1506 configured to receive coupled light from a sample 1502 at an input thereof and to obtain a spectrum of the sample 1502 based on the coupled light. The spectrometer 1406 may be, for example, a Fourier Transform infrared (FTIR) spectrometer operating in a diffuse reflectance mode. In the example shown in FIG. 15, the optical device 1500 further includes a light source 1504 (e.g., a lamp with a surrounding light source ellipsoid reflector 1538) positioned opposite the sample 1502 on one side thereof. The light source 1504 is configured to illuminate the sample 1502 with input light 1520 at a first spot 1534 on a first side 1528 thereof at a certain angle to produce scattered light 1522. An off-axis parabolic mirror 1510 is positioned to collect the scattered light 1522. More specifically, the center of an illumination spot (e.g., focused illumination spot 1508) on the sample 1502 is positioned at a focal point (e.g., off-axis parabolic mirror focal point 1514) of the mirror 1510. Accordingly, the mirror 1510 will produce a parallel set of rays 1524 corresponding to the scattered light 1522. Another off-axis parabolic mirror 1512 may be positioned to collect the parallel set of rays 1524 and to direct reflected scattered light 1526 to a second side 1530 of the sample 1502 opposite the first side 1528. The off-axis parabolic mirror 1512 may be configured to focus the reflected scattered light 1526 to a focal point thereof (e.g., off-axis parabolic mirror focal point 1516). The focused light 1526 interacts with the sample 1502 at a second spot 1536 for the second time to produce redirected scattered light 1532. The first spot 1528 and the second spot 1536 collective form an extended spot area on the sample 1502.

Collection optics (e.g., a lens 1518) is positioned to couple the redirected scattered light 1532 after the second interaction with the sample 1502. In this example, the redirected scattered light 1532 may include the directly coupled scattered light. The redirected scattered light 1532 may then be coupled into the spectrometer 1506. As a result, this configuration enables spectral measurement from the two sides 1528 and 1530 of the sample 1502. In addition, in this configuration, the parallel rays 1524 produced by the off-axis parabolic mirror 1510 enable longer propagation distances, which can be advantageous for thick samples 1502.

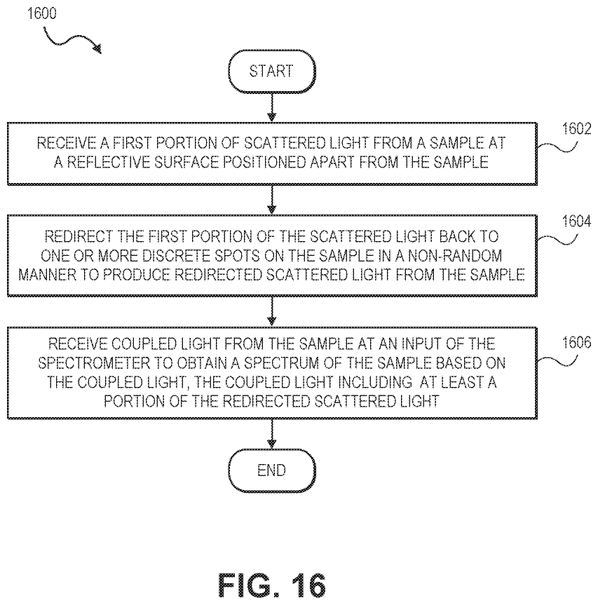

FIG. 16 is a flow chart illustrating an exemplary method 1600 for light redirection for spectrometer collection from a sample according to some aspects. As described below, some or all illustrated features may be omitted in a particular implementation within the scope of the present disclosure, and some illustrated features may not be required for implementation of all embodiments. In some examples, the method may be performed by the optical device 300, as described above and illustrated in FIG. 3, or by any configuration of the optical device, such as the configurations shown in FIGS. 3-15.

At block 1602, the optical device may receive a first portion of scattered light from a sample at a reflective surface positioned apart from the sample. In some examples, the reflective surface may include a half-sphere or a sphere.

At block 1604, the optical device may redirect the first portion of the scattered light back to one or more discrete spots on the sample in a non-random manner to produce redirected scattered light from the sample. In addition, at block 1606, the optical device may receive coupled light from the sample at an input of the spectrometer to obtain a spectrum of the sample based on the coupled light. The coupled light may include at least a portion of the redirected scattered light.

In some examples, the optical device may include an illumination system positioned between the reflective surface and the sample for illuminating the sample with input light. The input light may be scattered from the sample as the scattered light. In some examples, the coupled light includes a second portion of the scattered light directly coupled from the sample into the spectrometer.

In some examples, the one or more spots include a single spot within the field of view of the spectrometer. The single spot may have an extended spot size based on the redirected scattered light. In this example, the optical device may further be configured to receive another portion of the redirected scattered light at the reflective surface and may further redirect the other portion of the redirected scattered light back to the single spot on the sample to produce additional redirected scattered light. Here, the coupled light may further include at least a portion of the additional redirected scattered light. In some examples, the optical device may further reflect at least a portion of the input light back to the reflective surface via a diffuse reflective material on each side of the sample for redirection of the input light towards the single spot on the sample.

In some examples, the optical device may receive the first portion of the scattered light from a first spot on the sample having a spot area at least partially outside of a field of view of the spectrometer and may further redirect the first portion of the scattered light to a second spot on the sample within the field of view of the spectrometer. In this example, the first spot and the second spot form an extended spot area on the sample. In some examples, the optical device may further redirect the first portion of the scattered light to the second spot on the sample via a third spot on the sample that is at least partially outside of the field of view of the spectrometer. In this example, the extended spot area further includes the third spot.

In some examples, the illumination system may include at least two light sources, each configured to direct a respective portion of the input light to a respective spot on the sample. In this example, the optical device may receive the first portion of the scattered light at the reflective surface from each of the respective spots on the sample and redirect the first portion of the scattered light to a collection area on the sample within the field of view of the spectrometer from which the coupled light is directed to the spectrometer. Here, at least the respective spots on the sample form an extended spot area on the sample. In some examples, the collection area forms a collection spot on the sample, and the extended spot area further includes the collection spot. In some examples, the collection area includes a diffuse reflective material configured to direct the coupled light into the spectrometer.

In some examples, the reflective surface is a corner cube mirror. In this example, the optical device may further illuminate a first spot on the sample with the input light via a corrugated window positioned between the illumination system and the sample. The input light may be scattered from the sample as the first portion of the scattered light and directed towards the corner cube mirror via a second spot on the sample. In addition, the optical device may further redirect the first portion of the scattered light back from the corner cube mirror back to a third spot on the sample via the corrugated window to produce the redirected scattered light that is coupled into the spectrometer via a fourth spot on the sample. Here, the first spot, the second spot, the third spot, and the fourth spot form an extended spot area on the sample. In some examples, the optical device further includes a corrugated mirror and a heat dissipating element adjacent to the corrugated mirror. In this example, the sample may be sandwiched between the corrugated window and the corrugated mirror.

In some examples, the reflective surface includes a first off-axis parabolic mirror and a second off-axis parabolic mirror. In this example, the optical device may further receive the first portion of the scattered light at the first off-axis parabolic mirror from a first spot on a first side of the sample, direct the first portion of the scattered light as a set of parallel rays from the first off-axis parabolic mirror to the second off-axis parabolic mirror, and direct reflected scattered light corresponding to the set of parallel rays to a second spot on a second side of the sample opposite the first side to produce the redirected scattered light. Here, the first spot and the second spot from an extended spot area on the sample.

The following provides an overview of examples of the present disclosure.

Example 1: An optical device, comprising: An optical device, comprising: a reflective surface positioned apart from a sample and configured to receive a first portion of scattered light from the sample and to redirect the first portion of the scattered light back to one or more discrete spots on the sample in a non-random manner to produce redirected scattered light from the sample; and a spectrometer configured to receive coupled light from the sample at an input thereof and to obtain a spectrum of the sample based on the coupled light, the coupled light comprising at least a portion of the redirected scattered light.

Example 2: The optical device of example 1, further comprising: an illumination system positioned between the reflective surface and the sample and configured to illuminate the sample with input light that is scattered from the sample as the scattered light.

Example 3: The optical device of example 2, wherein the coupled light further comprises a second portion of the scattered light directly coupled from the sample into the spectrometer.

Example 4: The optical device of example 3, wherein the one or more spots comprise a single spot within a field of view of the spectrometer, the single spot having an extended spot size based on the redirected scattered light, and wherein the reflective surface is further configured to receive another portion of the redirected scattered light and to redirect the other portion of the redirected scattered light back to the single spot on the sample to produce additional redirected scattered light, wherein the coupled light further comprises at least a portion of the additional redirected scattered light.

Example 5: The optical device of example 4, further comprising: a diffuse reflective material on each side of the sample to reflect at least a portion of the input light back to the reflective surface for redirection of the input light towards the single spot on the sample.

Example 6: The optical device of example 4, wherein the reflective surface comprises a half-sphere or a sphere.

Example 7: The optical device of any of examples 2 through 6, wherein the reflective surface comprises a first section adjacent the illumination system and a second section configured to redirect the first portion of the scattered light, wherein the first section has a first curvature and the second section has a second curvature different than the first curvature.

Example 8: The optical device of example 7, wherein the first section comprises two outside sections and the illumination system comprises two light sources, each positioned adjacent to one of the two outside sections.

Example 9: The optical device of example 7 or 8, wherein the reflective surface completely surrounds the sample.

Example 10: The optical device of example 9, further comprising: a sample holder configured to hold the sample, wherein the sample holder extends in one of two perpendicular directions.

Example 11: The optical device of example 2, wherein the reflective surface is configured to receive the first portion of the scattered light from a first spot on the sample having a spot area at least partially outside of a field of view of the spectrometer and to redirect the first portion of the scattered light to a second spot on the sample within the field of view of the spectrometer, wherein the first spot and the second spot form an extended spot area on the sample.

Example 12: The optical device of example 11, wherein the reflective surface is further configured to redirect the first portion of the scattered light to the second spot on the sample via a third spot on the sample that is at least partially outside of the field of view of the spectrometer, wherein the extended spot area further comprises the third spot.

Example 13: The optical device of example 2, wherein the illumination system comprises at least two light sources, each configured to direct a respective portion of the input light to a respective spot on the sample, and wherein the reflective surface is configured to receive the first portion of the scattered light from each of the respective spots on the sample and to redirect the first portion of the scattered light to a collection area within a field of view of the spectrometer from which the coupled light is directed to the spectrometer, wherein at least the respective spots on the sample form an extended spot area on the sample.

Example 14: The optical device of example 13, wherein the collection area forms a collection spot on the sample, and the extended spot area further comprises the collection spot.

Example 15: The optical device of example 13, wherein the collection area comprises a diffuse reflective material configured to direct the coupled light into the spectrometer.

Example 16: The optical device of any of examples 13 through 15, wherein the reflective surface comprises respective outside sections, each having one of the two light sources positioned adjacent thereto, an inside section, and respective additional sections between the respective outside sections and the inside section, wherein the inside section and the respective additional sections are configured to redirect the first portion of the scattered light to the collection area, wherein the outside sections, the additional sections, and the inside section each comprise a different respective curvature.

Example 17: The optical device of example 2, wherein the reflective surface comprises a corner cube mirror, and further comprising: a corrugated window positioned between the illumination system and the sample positioned, wherein the illumination system is configured to illuminate the sample with the input light via the corrugated window at a first spot on the sample, the input light being scattered from the sample as the first portion of the scattered light and directed towards the corner cube mirror via a second spot on the sample, wherein the corner cube mirror is configured to redirect the first portion of the scattered light back to a third spot on the sample via the corrugated window to produce the redirected scattered light that is coupled into the spectrometer via a fourth spot on the sample, wherein the first spot, the second spot, the third spot, and the fourth spot form an extended spot area on the sample.

Example 18: The optical device of example 17, further comprising: a corrugated mirror, the sample being sandwiched between the corrugated window and the corrugated mirror; and a heat dissipating element adjacent to the corrugated mirror.

Example 19: The optical device of example 2, wherein the reflective surface comprises a first off-axis parabolic mirror and a second off-axis parabolic mirror, the first off-axis parabolic mirror being configured to receive the first portion of the scattered light from a first spot on a first side of the sample and to direct the first portion of the scattered light as a set of parallel rays to the second off-axis parabolic mirror, the second off-axis parabolic mirror being configured to collect the set of parallel rays and to direct reflected scattered light corresponding to the set of parallel rays to a second spot on a second side of the sample opposite the first side to produce the redirected scattered light, wherein the first spot and the second spot from an extended spot area on the sample.

Example 20: A method for increasing collection of a spectrometer using the optical device of any one of examples 1 through 19.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-16 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-16 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(1) unless the element is expressly recited using the phrase “means for” or, in the case of a method claim, the element is recited using the phrase “step for.”

What is claimed is:

1. An optical device, comprising:
a reflective surface positioned apart from a sample and configured to receive a first portion of scattered light from the sample and to redirect the first portion of the scattered light back to one or more discrete spots on the sample in a non-random manner to produce redirected scattered light from the sample; and
a spectrometer configured to receive coupled light from the sample at an input thereof and to obtain a spectrum of the sample based on the coupled light, the coupled light comprising at least a portion of the redirected scattered light.

2. The optical device of claim 1, further comprising:
an illumination system positioned between the reflective surface and the sample and configured to illuminate the sample with input light that is scattered from the sample as the scattered light.

3. The optical device of claim 1, wherein the coupled light further comprises a second portion of the scattered light directly coupled from the sample into the spectrometer.

4. The optical device of claim 3, wherein the one or more spots comprise a single spot within a field of view of the spectrometer, the single spot having an extended spot size based on the redirected scattered light, and wherein the reflective surface is further configured to receive another portion of the redirected scattered light and to redirect the other portion of the redirected scattered light back to the single spot on the sample to produce additional redirected scattered light, wherein the coupled light further comprises at least a portion of the additional redirected scattered light.

5. The optical device of claim 4, further comprising:
a diffuse reflective material on each side of the sample to reflect at least a portion of the input light back to the reflective surface for redirection of the input light towards the single spot on the sample.

6. The optical device of claim 4, wherein the reflective surface comprises a half-sphere or a sphere.

7. The optical device of claim 2, wherein the reflective surface comprises a first section adjacent the illumination system and a second section configured to redirect the first portion of the scattered light, wherein the first section has a first curvature and the second section has a second curvature different than the first curvature.

8. The optical device of claim 7, wherein the first section comprises two outside sections and the illumination system comprises two light sources, each positioned adjacent to one of the two outside sections.

9. The optical device of claim 7, wherein the reflective surface completely surrounds the sample.

10. The optical device of claim 9, further comprising:
a sample holder configured to hold the sample, wherein the sample holder extends in one of two perpendicular directions.

11. The optical device of claim 2, wherein the reflective surface is configured to receive the first portion of the scattered light from a first spot on the sample having a spot area at least partially outside of a field of view of the spectrometer and to redirect the first portion of the scattered light to a second spot on the sample within the field of view of the spectrometer, wherein the first spot and the second spot form an extended spot area on the sample.

12. The optical device of claim 11, wherein the reflective surface is further configured to redirect the first portion of the scattered light to the second spot on the sample via a third spot on the sample that is at least partially outside of the field of view of the spectrometer, wherein the extended spot area further comprises the third spot.

13. The optical device of claim 2, wherein the illumination system comprises at least two light sources, each configured to direct a respective portion of the input light to a respective spot on the sample, and wherein the reflective surface is configured to receive the first portion of the scattered light from each of the respective spots on the sample and to redirect the first portion of the scattered light to a collection area within a field of view of the spectrometer from which the coupled light is directed to the spectrometer, wherein at least the respective spots on the sample form an extended spot area on the sample.

14. The optical device of claim 13, wherein the collection area forms a collection spot on the sample, and the extended spot area further comprises the collection spot.

15. The optical device of claim 13, wherein the collection area comprises a diffuse reflective material configured to direct the coupled light into the spectrometer.

16. The optical device of claim 13, wherein the reflective surface comprises respective outside sections, each having one of the two light sources positioned adjacent thereto, an inside section, and respective additional sections between the respective outside sections and the inside section, wherein the inside section and the respective additional sections are configured to redirect the first portion of the scattered light to the collection area, wherein the outside sections, the additional sections, and the inside section each comprise a different respective curvature.

17. The optical device of claim 2, wherein the reflective surface comprises a corner cube mirror, and further comprising:
a corrugated window positioned between the illumination system and the sample positioned,
wherein the illumination system is configured to illuminate the sample with the input light via the corrugated window at a first spot on the sample, the input light being scattered from the sample as the first portion of the scattered light and directed towards the corner cube mirror via a second spot on the sample,
wherein the corner cube mirror is configured to redirect the first portion of the scattered light back to a third spot on the sample via the corrugated window to produce the redirected scattered light that is coupled into the spectrometer via a fourth spot on the sample, wherein the first spot, the second spot, the third spot, and the fourth spot form an extended spot area on the sample.

18. The optical device of claim 17, further comprising:
a corrugated mirror, the sample being sandwiched between the corrugated window and the corrugated mirror; and
a heat dissipating element adjacent to the corrugated mirror.

19. The optical device of claim 2, wherein the reflective surface comprises a first off-axis parabolic mirror and a second off-axis parabolic mirror, the first off-axis parabolic mirror being configured to receive the first portion of the scattered light from a first spot on a first side of the sample and to direct the first portion of the scattered light as a set of parallel rays to the second off-axis parabolic mirror, the second off-axis parabolic mirror being configured to collect the set of parallel rays and to direct reflected scattered light corresponding to the set of parallel rays to a second spot on a second side of the sample opposite the first side to produce the redirected scattered light, wherein the first spot and the second spot from an extended spot area on the sample.

20. A method for increasing collection of a spectrometer, comprising:
receiving a first portion of scattered light from a sample at a reflective surface positioned apart from the sample;
redirecting the first portion of the scattered light back to one or more discrete spots on the sample in a non-random manner to produce redirected scattered light from the sample; and
receiving coupled light from the sample at an input of the spectrometer to obtain a spectrum of the sample based on the coupled light, the coupled light comprising at least a portion of the redirected scattered light.

21. The method of claim 20, further comprising:
illuminating the sample with input light from an illumination system positioned between the reflective surface and the sample, wherein the input light is scattered from the sample as the scattered light.

22. The method of claim 21, wherein the coupled light further comprises a second portion of the scattered light directly coupled from the sample into the spectrometer.

23. The method of claim 22, wherein the one or more spots comprise a single spot within a field of view of the spectrometer, the single spot having an extended spot size based on the redirected scattered light, and further comprising:
receiving another portion of the redirected scattered light at the reflective surface; and
redirecting the other portion of the redirected scattered light back to the single spot on the sample to produce additional redirected scattered light, wherein the coupled light further comprises at least a portion of the additional redirected scattered light.

24. The method of claim 23, further comprising:
reflecting at least a portion of the input light back to the reflective surface via a diffuse reflective material on each side of the sample for redirection of the input light towards the single spot on the sample.

25. The method of claim 23, wherein the reflective surface comprises a half-sphere or a sphere.

26. The method of claim 21, further comprising:
receiving the first portion of the scattered light at the reflective surface from a first spot on the sample having a spot area at least partially outside of a field of view of the spectrometer; and
redirecting the first portion of the scattered light to a second spot on the sample within the field of view of the spectrometer, wherein the first spot and the second spot form an extended spot area on the sample.

27. The method of claim 26, further comprising:
redirecting the first portion of the scattered light to the second spot on the sample via a third spot on the sample that is at least partially outside of the field of view of the spectrometer, wherein the extended spot area further comprises the third spot.

28. The method of claim 21, wherein the illumination system comprises at least two light sources, each configured to direct a respective portion of the input light to a respective spot on the sample, and further comprising:
receiving the first portion of the scattered light from each of the respective spots on the sample at the reflective surface; and
redirecting the first portion of the scattered light to a collection area within a field of view of the spectrometer from which the coupled light is directed to the spectrometer, wherein at least the respective spots on the sample form an extended spot area on the sample.

29. The method of claim 21, wherein the reflective surface comprises a corner cube mirror, and further comprising:
illuminating a first spot on the sample with the input light via a corrugated window positioned between the illumination system and the sample, the input light being scattered from the sample as the first portion of the scattered light and directed towards the corner cube mirror via a second spot on the sample; and
redirecting the first portion of the scattered light back from the corner cube mirror back to a third spot on the sample via the corrugated window to produce the redirected scattered light that is coupled into the spectrometer via a fourth spot on the sample, wherein the first spot, the second spot, the third spot, and the fourth spot form an extended spot area on the sample.

30. The method of claim 21, wherein the reflective surface comprises a first off-axis parabolic mirror and a second off-axis parabolic mirror, and further comprising:
receiving the first portion of the scattered light at the first off-axis parabolic mirror from a first spot on a first side of the sample;
directing the first portion of the scattered light as a set of parallel rays from the first off-axis parabolic mirror to the second off-axis parabolic mirror; and
directing reflected scattered light corresponding to the set of parallel rays to a second spot on a second side of the sample opposite the first side to produce the redirected scattered light, wherein the first spot and the second spot from an extended spot area on the sample.
